(19) United States
(12) Patent Application Publication
(10) Pub. No.: US 2011/0255116 A1
(43) Pub. Date: Oct. 20, 2011

(54) INFORMATION VIEWING SYSTEM, IMAGE FORMING APPARATUS AND INFORMATION VIEWING APPARATUS

(75) Inventors: Masayuki INOUE, Hachioji-shi (JP); Tetsuhiro Shibata, Sagamihara-shi (JP); Tatsuya Eguchi, Hachioji-shi (JP); Tsutomu Suka, Fussa-shi (JP); Keiichiro Hyodo, Kokubunji-shi (JP); Shunsuke Takamura, Hachioji-shi (JP)

(73) Assignee: Konica Minolta Business Technologies, Inc., Tokyo (JP)

(21) Appl. No.: 13/081,951

(22) Filed: Apr. 7, 2011

(30) Foreign Application Priority Data
Apr. 19, 2010 (JP) 2010-096190

(51) Int. Cl. G06F 15/00

(52) U.S. Cl. 358/1.13

(57) ABSTRACT

Disclosed is the information viewing system, which makes it possible to speedily output an image represented by data even when an operation for outputting the image onto a predetermined medium is disabled. The system includes an information viewing apparatus, a supporting device to detachably support the information viewing apparatus and the image forming apparatus onto which the supporting device is mountable. The system is so constituted that, in case that a data writing operation onto the printing medium becomes impossible at the time of commencing or in mid-course of implementing the data writing operation onto the printing medium, while the data writing operation onto the information viewing apparatus is enabled, the image forming apparatus changes the writing destination medium from the printing medium to the information viewing apparatus, in order to continuously implement the data writing operation onto the information viewing apparatus instead of the printing medium, and vice versa.

This application is based on Japanese Patent Application NO. 2010-096190 filed on Apr. 19, 2010, with Japan Patent Office, the entire content of which is hereby incorporated by reference.

### BACKGROUND OF THE INVENTION

The present invention relates to an information viewing system, an image forming apparatus and an information viewing apparatus, in each of which it is possible to view information indicated on plural kinds of media.

Various kinds of printing apparatuses, such as a printer, a Digital MFP (Multi Function Peripheral), etc., (hereinafter, referred to as an image forming apparatus, as a general term of them) has been proliferated in the market, and have been widely introduced into various kinds of companies or the like. In a normal operating status, when receiving a job transmitted form a client terminal device, such as a personal computer or the like, the image forming apparatus immediately prints an image, represented by image data included in the job, onto a paper sheet and outputs the printed paper sheet. However, in case that a trouble, such as a jamming of paper sheet, a running out of paper sheet, a running out of toner ink, a job waiting standby state, a calibration waiting standby state, etc., has occurred, it becomes impossible for the image forming apparatus to implement the print job concerned until the trouble is resolved. Accordingly, in that case, the user has been obliged to wait in front of the image forming apparatus concerned.

To solve the abovementioned problem, Tokkai 2002-64662 (Japanese Patent Application Laid-Open Publication) sets forth such the method for implementing the restoration processing that comprises: when determining that the running out of toner is detected in an image forming apparatus (occurrence of an interruption factor), determining whether or not a job, being currently implemented in the image forming apparatus concerned, should be recovered by another printer; when the operator selects a specific printer to recover the job concerned, transferring the data, included in the job implemented by the image forming apparatus so far, to the specific printer, so as to make the specific printer implement the job concerned; and replenishing toner into the image forming apparatus concerned while the specific printer is implementing the job concerned.

Further, Tokkai 2002-187331 (Japanese Patent Application Laid-Open Publication) sets forth the other method for storing the information, which indicates that the image forming apparatus is in mid-course of calibration, so as to allot the job, which has been allotted to the image forming apparatus currently in mid-course of calibration, to the other image forming apparatus.

The technology set forth in Tokkai 2002-64662 is to substitute the other printer in place of the image forming apparatus in which the image processing for implementing the concerned job is currently halted, while the other technology set forth in Tokkai 2002-187331 is to substitute the other image forming apparatus in place of the image forming apparatus currently in mid-course of calibration. However, according to the above-cited conventional technologies, since at least two sets of image forming apparatuses are necessary for continuously implementing the print job concerned, an incredible cost increase should be accepted when the other image forming apparatus is newly introduced.

Further, according to the above-cited conventional technologies, the user should recognize the other image forming apparatus, which currently serves as the printout destination apparatus, from the plural image forming apparatuses coupled to the system, and should go to the other image forming apparatus to take the print product therefrom. Therefore, when the print product is outputted from the other image forming apparatus that is installed at a place being far from the user's home place (for instance, the other image forming apparatus that is installed in an office floor of another department or on a floor outside the user's office room), a time loss for going to the other image forming apparatus has been inevitably generated.

### SUMMARY OF THE INVENTION

To overcome the abovementioned drawbacks in a conventional information viewing system, it is one of objects of the present invention to provide an information viewing system, an image forming apparatus and an information viewing apparatus, each of which makes it possible to speedily output an image represented by data even when an operation for outputting the image represented by the data onto a predetermined medium is disabled.

Accordingly, at least one of the objects of the present invention can be attained by any one of the information viewing system, the image forming apparatus and the information viewing apparatus, described as follows.

(1) According to an information viewing system reflecting an aspect of the present invention, the information viewing system comprises: at least a single set of an information viewing apparatus provided with a display section; a supporting device that is configured to detachably support the information viewing apparatus; an image forming apparatus onto which the supporting device is mountable; and a computer apparatus that instructs the image forming apparatus to output an image represented by data; wherein the information viewing apparatus, the supporting device, the image forming apparatus and the computer apparatus are communicatively coupled to each other, so as to make it possible to select any one of a printing medium accommodated in the image forming apparatus and the information viewing apparatus mounted on the supporting device as a writing destination medium, when the image represented by the data is to be outputted onto the writing destination medium; and wherein, in case that a data writing operation, defined as an operation for writing the image represented by the data, onto the printing medium becomes impossible at a time of commencing the data writing operation or in mid-course of implementing the data writing operation onto the printing medium, while the data writing operation onto the information viewing apparatus is enabled, the image forming apparatus changes the writing destination medium from the printing medium to the information viewing apparatus, in order to implement the data writing operation onto the information viewing apparatus instead of the printing medium; and wherein, in case that the data writing operation onto the information viewing apparatus becomes impossible at a time of commencing the data writing operation or in mid-course of implementing the data writing operation onto the information viewing apparatus, while the data writing operation onto the printing medium is enabled, the image forming apparatus changes the writing destination medium from the information viewing apparatus to the printing medium, in order to implement the data writing operation onto printing medium instead of the information viewing apparatus.
(2) According to another aspect of the present invention, in the information viewing system recited in item 1, when changing the writing destination medium, the image forming apparatus also changes output conditions of the data, corresponding to the writing destination medium to be changed.
(3) According to still another aspect of the present invention, in the information viewing system recited in item 1, when changing the writing destination medium from the printing medium to one of plural information viewing apparatuses currently supported by the supporting device, the image forming apparatus selects such an information viewing apparatus that is in conformity with output conditions of the data from the plural information viewing apparatuses as the information viewing apparatus.
(4) According to still another aspect of the present invention, in the information viewing system recited in item 2 or 3, the output conditions include at least any one of an output image size, a resolution, a color/monochrome printing mode, a page allotment and a single-side/duplex printing mode.
(5) According to still another aspect of the present invention, in the information viewing system recited in item 1, when receiving plural data sets, which are respectively related to plural users being different from each other, and when changing the writing destination medium from the printing medium to the information viewing apparatus, the image forming apparatus discretely writes each of the plural data sets onto corresponding one of information viewing apparatuses, which are respectively allotted to the plural users.
(6) According to still another aspect of the present invention, in the information viewing system recited in any one of items 1-5, when instructing the data writing operation, the computer apparatus is capable of determining whether an operation for changing the writing destination medium is enabled or disabled; and the image forming apparatus implements the operation for changing the writing destination medium, when the computer apparatus has determined that the operation for changing the writing destination medium should be enabled.
(7) According to still another aspect of the present invention, in the information viewing system recited in any one of items 1-5, before receiving the data or when the data writing operation onto a predetermined medium becomes impossible, the image forming apparatus is capable of determining whether an operation for changing the writing destination medium is enabled or disabled; and the image forming apparatus implements the operation for changing the writing destination medium, when the image forming apparatus has determined that the operation for changing the writing destination medium should be enabled.
(8) According to an image forming apparatus reflecting still another aspect of the present invention, the image forming apparatus, onto which a supporting device that is configured to detachably support at least a single set of an information viewing apparatus, provided with a display section, is mountable, comprises: a data processing section to output data representing an image to be printed or displayed onto a writing destination medium; and a controlling section to select any one of a printing medium and the information viewing apparatus as the writing destination medium, when the image represented by the data is to be outputted onto the writing destination medium; wherein, in case that a data writing operation, defined as an operation for writing the image represented by the data, onto the printing medium becomes impossible at a time of commencing the data writing operation or in mid-course of implementing the data writing operation onto the printing medium, while the data writing operation onto the information viewing apparatus is enabled, the controlling section changes the writing destination medium from the printing medium to the information viewing apparatus, in order to implement the data writing operation onto the information viewing apparatus instead of the printing medium; and wherein, in case that the data writing operation onto the information viewing apparatus becomes impossible at a time of commencing the data writing operation or in mid-course of implementing the data writing operation onto the information viewing apparatus, while the data writing operation onto the printing medium is enabled, the controlling section changes the writing destination medium from the information viewing apparatus to the printing medium, in order to implement the data writing operation onto printing medium instead of the information viewing apparatus.
(9) According to an information viewing apparatus reflecting yet another aspect of the present invention, the information viewing apparatus, which is supported by a supporting device that is configured to detachably support the information viewing apparatus and that is mounted onto an image forming apparatus, comprises: a display section to display an image thereon; and a data processing section that is configured to change output conditions of data representing the image, corresponding to the information viewing apparatus, so as to display the image represented by the data onto the display section, when the image forming apparatus changes a writing destination medium, onto which a data writing operation, defined as an operation for writing the image represented by the data, is to be implemented, to the information viewing apparatus concerned.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram indicating a configuration of an information viewing system embodied in the present invention;

FIG. 2 shows a schematic diagram indicating a perspective view of an exemplary image forming apparatus, in which an information viewing apparatus and a supporting device thereof are installed;

FIG. 3 shows a schematic diagram indicating a perspective view of an exemplary image forming apparatus, in which a plurality of information viewing apparatuses and a supporting device thereof are installed;

FIG. 4 shows a block diagram indicating a configuration of an information viewing apparatus, embodied in the present invention;

FIG. 5 shows a block diagram indicating a configuration of a supporting device, embodied in the present invention;

FIG. 6 shows a block diagram indicating a configuration of a supporting device, embodied in the present invention;

FIG. 7 shows a block diagram indicating a configuration of a computer apparatus, embodied in the present invention;

FIG. 8 shows a flowchart indicating operations to be conducted in the information viewing apparatus embodied in the present invention, when a writing medium change operation is to be automatically implemented;

FIG. 9 shows another flowchart indicating operations to be conducted in the information viewing apparatus embodied in the present invention, when a writing medium change operation is to be implemented according to a determination established in advance;

FIG. 10a shows a perspective view indicating a state of mounting a plurality of information viewing apparatuses into a supporting device, while FIG. 10b shows a perspective view indicating another state of mounting a plurality of information viewing apparatuses into a supporting device;

FIG. 11a shows a schematic diagram indicating a conventional print property screen (prior art) to be displayed on a computer apparatus, while FIG. 11b shows a schematic diagram indicating a novel print property screen (embodied in the present invention) to be displayed on a computer apparatus;

FIG. 12a shows a schematic diagram indicating an exemplified screen (notification screen) to be displayed on an image forming apparatus, while FIG. 12b shows a schematic diagram indicating an exemplified screen (medium change setting screen) to be displayed on an image forming apparatus; and

FIG. 13-1 shows a schematic diagram indicating a part of an exemplary table to be referred at the time when an operation for determining a change of a writing medium is implemented, and FIG. 13-2 shows a schematic diagram indicating another part of the exemplary table as a continuation of the exemplary table shown in FIG. 13-1.

### DETAILED DESCRIPTION OF THE PREFERRED EMBODIMENT

As described in the “BACKGROUND OF THE INVENTION”, in case that a kind of trouble, such as a jamming of paper sheet, a running out of paper sheet, a running out of toner ink, a job waiting standby state, a calibration waiting standby state, etc., has occurred, sometimes, the image forming apparatus halts the operation for writing an image onto a recording medium to solve the problem concerned. In this case, the user has been obliged to wait the resumption of the outputting operation, until the concerned problem is solved. Conventionally, to solve the abovementioned problem, when a trouble in regard to the outputting operation has occurred in a certain image forming apparatus among plural image forming apparatuses provided in the printing system, there has been proposed such the method that makes another image forming apparatus output the print product as the substitution of the image forming apparatus currently halted. However, the conventional method has caused not only an incredible cost increase of the printing system concerned, but also a time loss, due to the fact that the user should recognize the other image forming apparatus, which currently serves as the printout destination apparatus, from the plural image forming apparatuses coupled to the system, and should go to the other image forming apparatus to take the print product therefrom.

On the other hand, in recent years, various kinds of portable-type information viewing apparatuses, such as an electronic paper sheet or the like, have been proliferated in the market. Accordingly, it is possible to employ the information viewing apparatus, abovementioned, instead of the printing medium.

In this connection, according to an embodiment of the present invention, in the system that includes an image forming apparatus to which a supporting device for supporting an information viewing apparatus in a detachable manner, it is possible to determine whether the outputted data should be written into the printing medium or the information viewing apparatus in a selectable manner. Then, when it becomes impossible for the status of the image forming apparatus to write the data into the printing medium (or the information viewing apparatus) at the time when the data writing operation is commenced, or during the time in mid-course of the data writing operation, if it is possible to write the data into the information viewing apparatus (or the printing medium), the writing destination medium is changed from the printing medium (or the information viewing apparatus) to the information viewing apparatus (or the printing medium), so as to continuously implement the data writing operation.

As abovementioned, by changing the writing destination medium, which is to be implemented but currently halted, to another kind of writable medium, it becomes unnecessary for the user to wait the resumption of the data writing operation until the data is actually outputted, resulting in an improvement of the user's convenience.

### EMBODIMENT

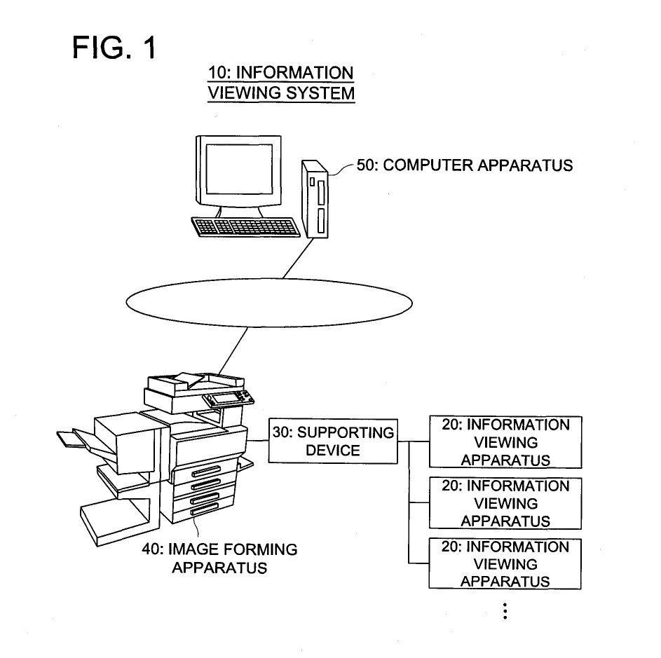

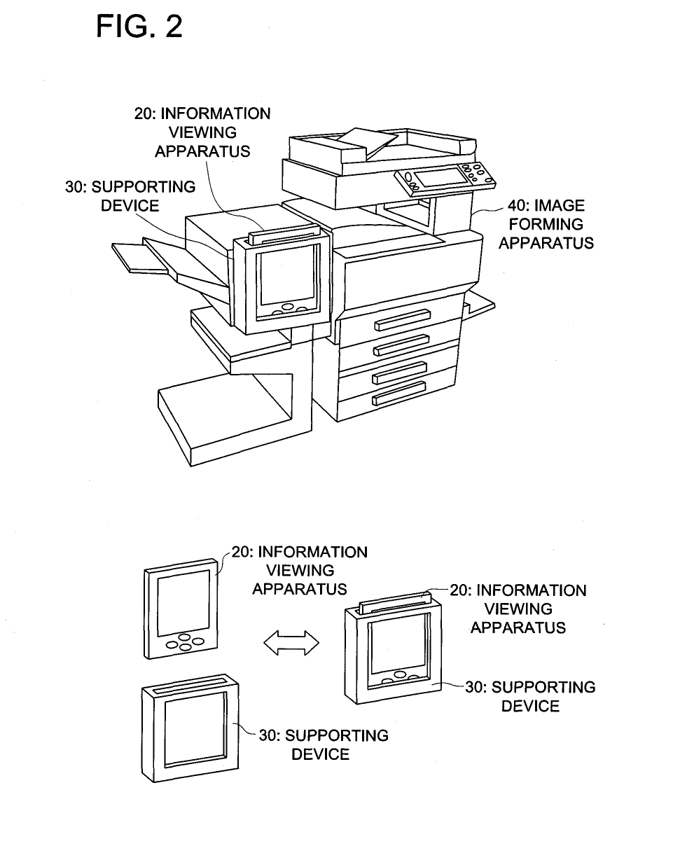

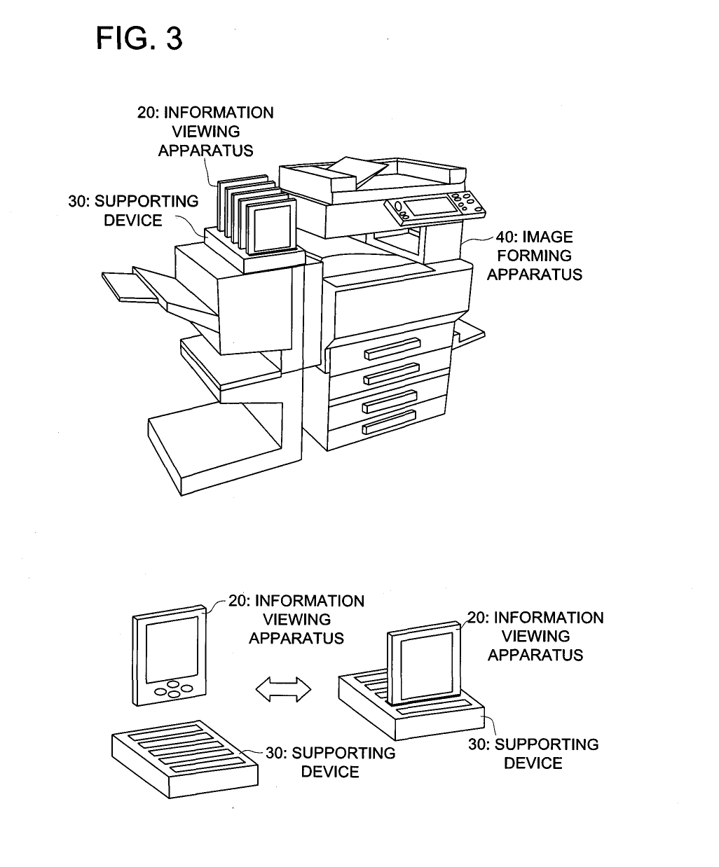

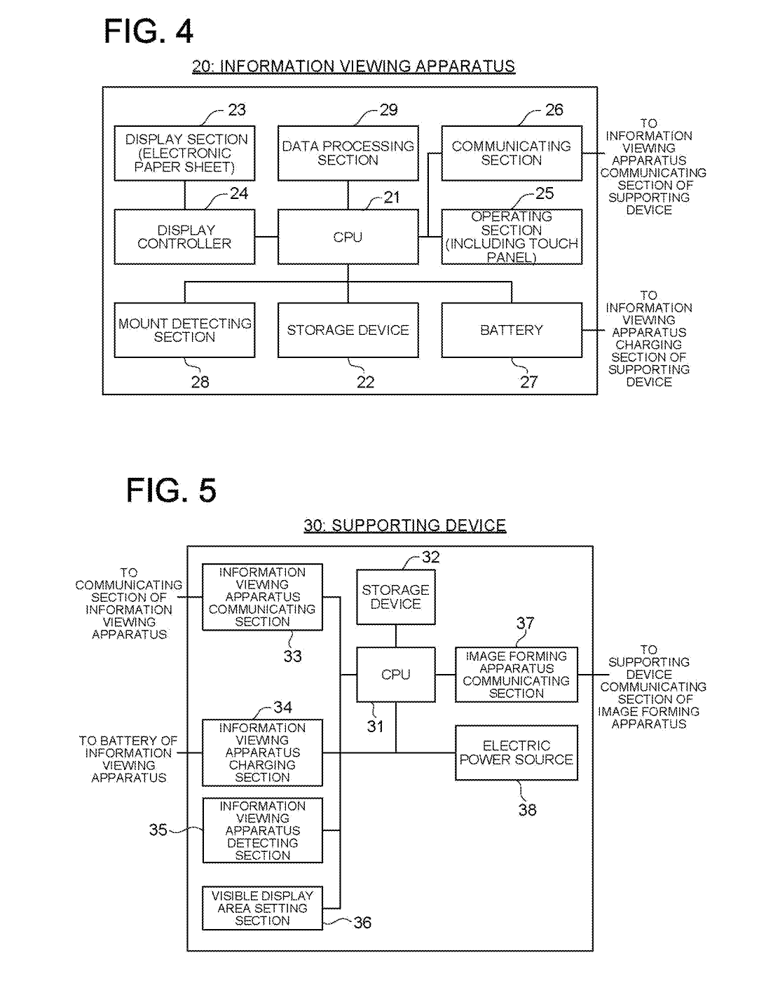

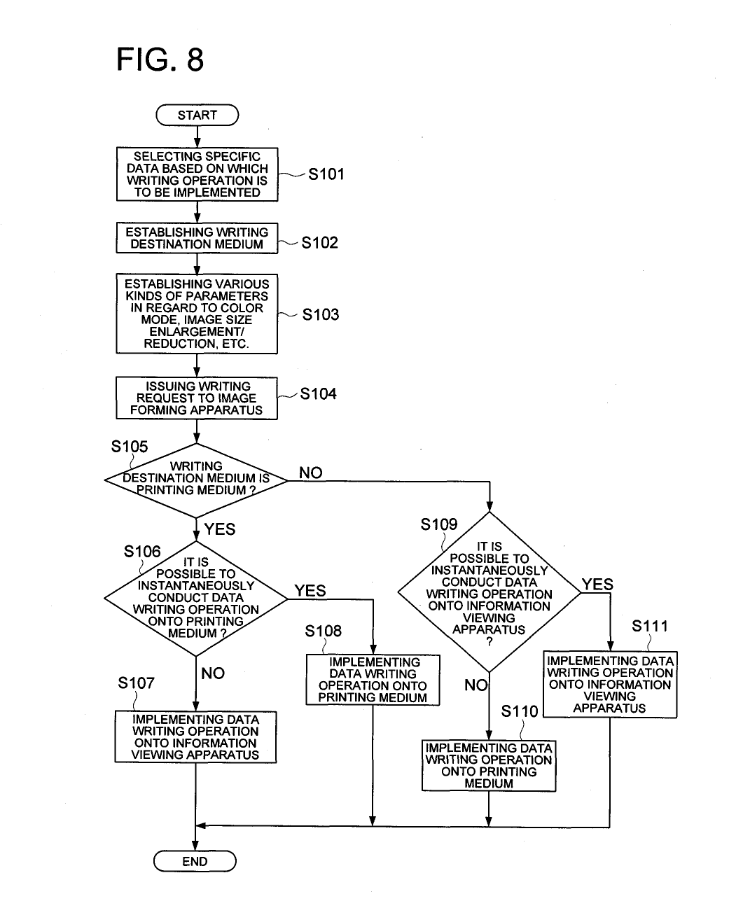

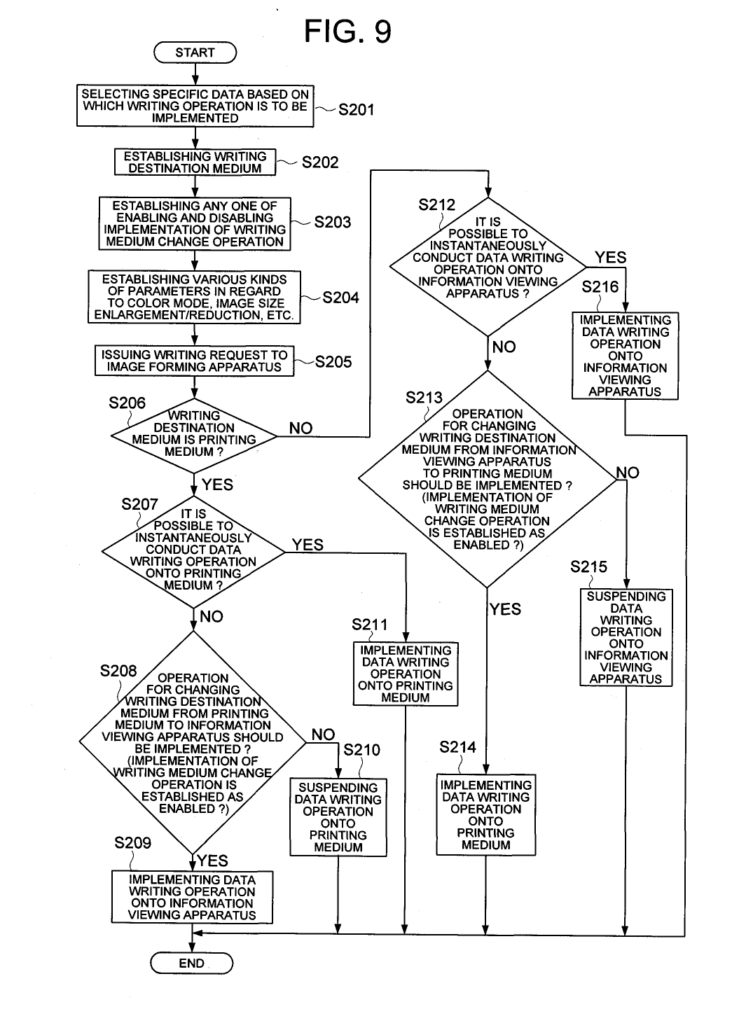

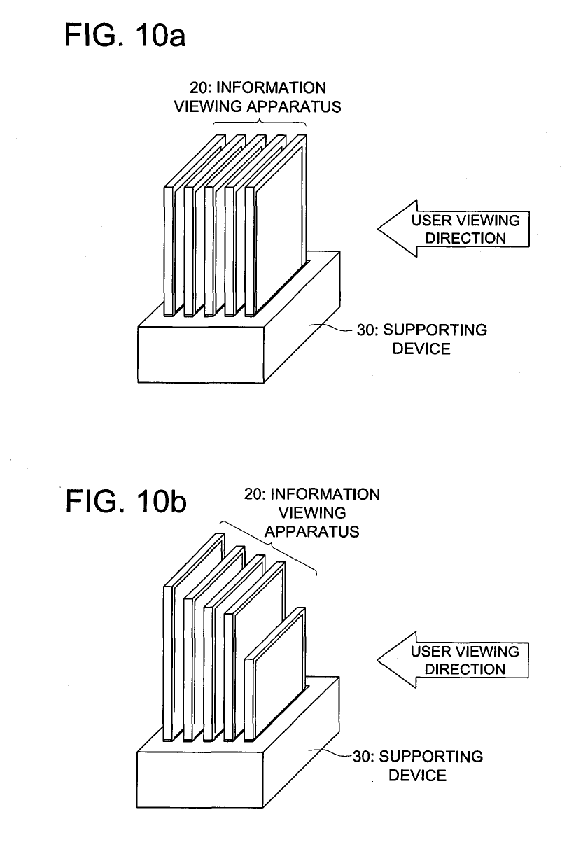

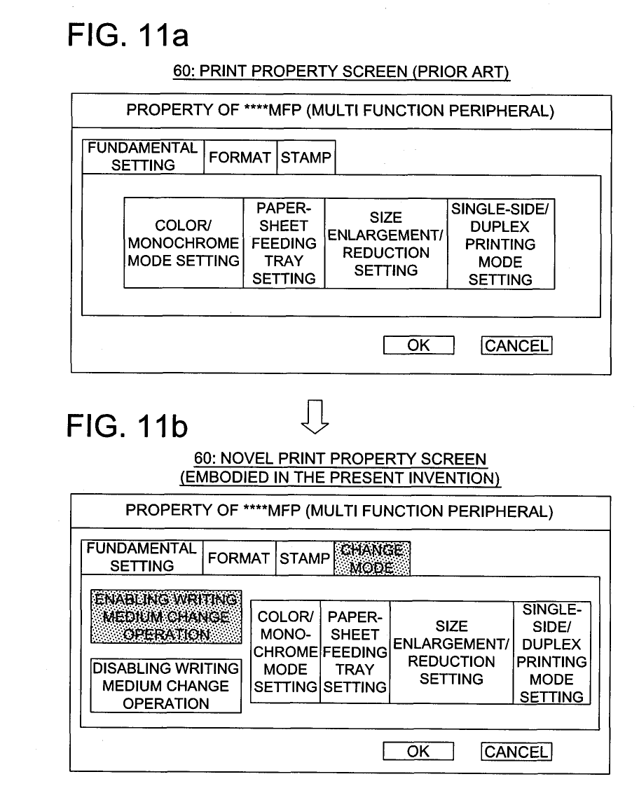

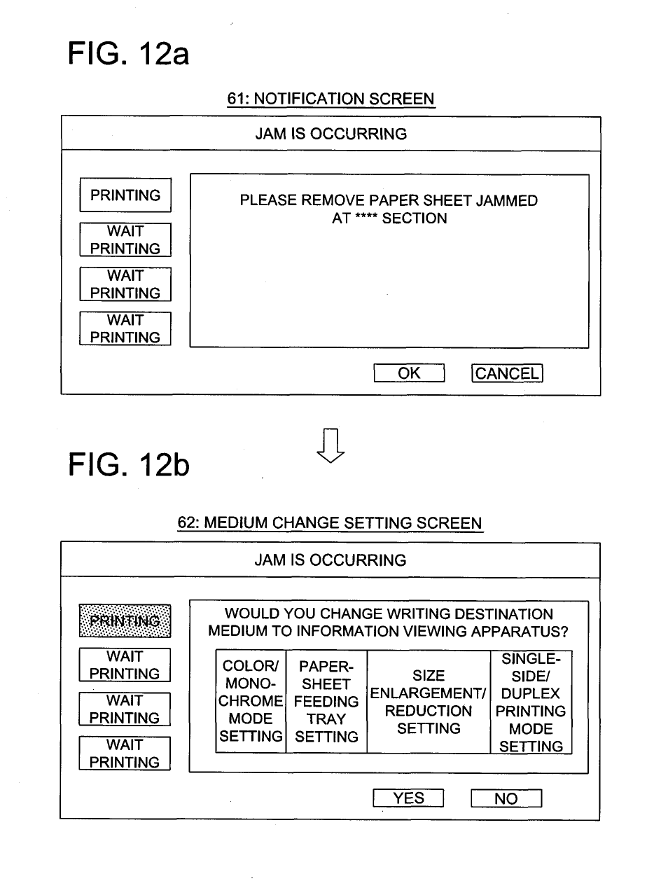

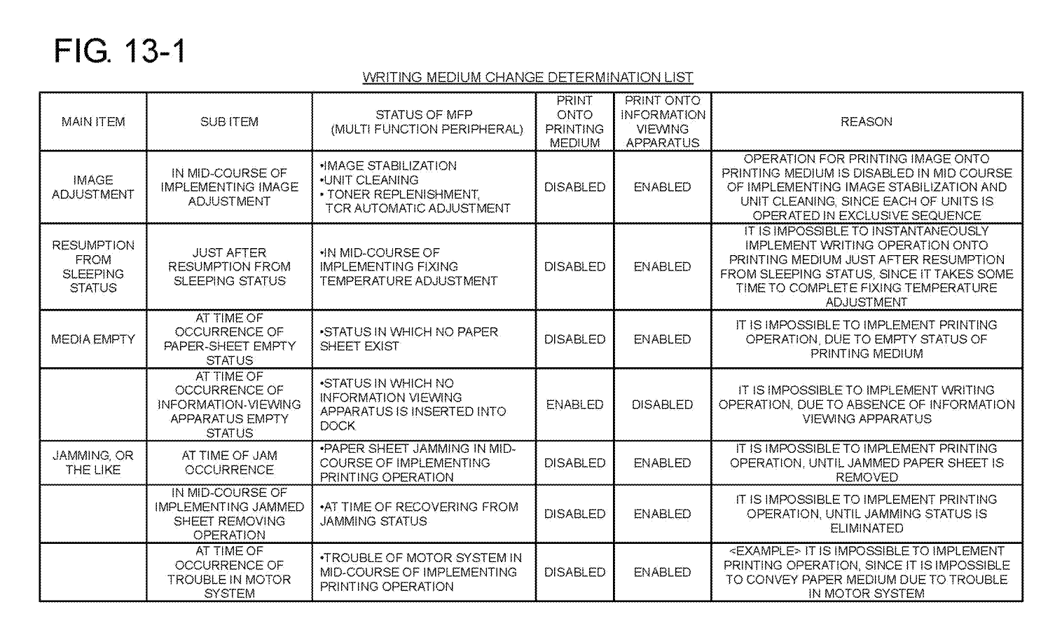

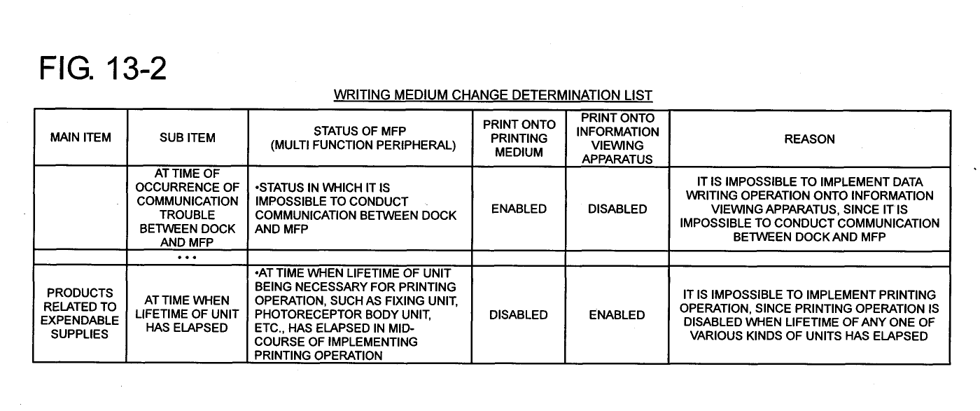

In order to further describe the preferred embodiment of the present invention in detail, referring to FIG. 1 through FIG. 13, an information viewing system, an image forming apparatus and an information viewing apparatus, embodied in the present invention, will be detailed in the following. FIG. 1 shows a schematic diagram indicating a configuration of the information viewing system embodied in the present invention; FIG. 2 and FIG. 3 show schematic diagrams indicating perspective views of exemplary image forming apparatuses, in each of which the information viewing apparatuses and supporting devices thereof are installed; FIG. 4 through FIG. 7 show block diagrams indicating the configurations of the information viewing apparatus, the supporting device, the image forming apparatus and a computer apparatus, respectively. Further, FIG. 8 and FIG. 9 show flowcharts indicating operations to be conducted in the information viewing apparatus embodied in the present invention; and FIG. 10a and FIG. 10b show perspective views indicating states of mounting a plurality of information viewing apparatuses into the supporting device. Still further, FIG. 11a and FIG. 11b show schematic diagrams indicating exemplified print property screens to be displayed on the computer apparatus; FIG. 12a and FIG. 12b show schematic diagrams indicating exemplified notifying screens (output medium change setting screen) to be displayed on the image forming apparatus; and FIG. 13 shows a schematic diagram indicating an exemplary table to be referred at the time when the operation for determining the change of the writing medium is implemented.

As shown in FIG. 1, an information viewing system 10, embodied in the present invention, is constituted by: a computer apparatus 50, serving as a client terminal device that transmits a job; an image forming apparatus 40, such as MFP (Multi Function Peripheral), etc., that processes (printing or transferring) the job received from the computer apparatus 50; a supporting device 30 (DOCK) that is installed into the image forming apparatus 40; and an information viewing apparatus 20 that is supported by the supporting device 30 in a detachable manner.

The schematic diagrams shown FIG. 2 and FIG. 3 exemplify the image forming apparatus 40 into which the supporting device 30 for supporting the information viewing apparatus 20 is installed, wherein the supporting device 30 is mounted onto the predetermined position of the image forming apparatus 40, and the information viewing apparatus 20 is inserted into a slot of the supporting device 30. Now, each of the abovementioned apparatuses and devices will be detailed in the following.

### <Information Viewing Apparatus>

The information viewing apparatus 20 is such an apparatus that is provided with a display device, such as an electronic paper sheet, an electronic book, a thin-type computer apparatus, etc., and as shown in FIG. 4, the information viewing apparatus 20 is constituted by a CPU (Central Processing Unit) 21, a storage device 22, a display section (electronic paper sheet) 23, a display controller 24, an operating section (touch panel) 25, a communicating section 26, a battery 27, a mount detecting section 28, a data processing section 29, etc.

The CPU 21 executes various kinds of programs read from the storage device 22 so as to control the operations to be conducted in the various kinds of sections. The storage device 22 is constituted by a ROM (Read Only Memory) and a RAM (Random Access Memory), so as to store the various kinds of programs to be executed by the CPU 21, setting information for controlling the operations to be conducted by the information viewing apparatus 20, various kinds of data transferred from the supporting device 30 (and/or data processed by the data processing section 29), identification information for identifying the user, etc., therein. Further, the CPU 21 and the storage device 22 constitute a controlling section.

The display section 23 is constituted by an electronic paper sheet, serving as an EPD (Electro-Phoretic Display or Electrophoretic Display) in which the displaying action is achieved by the motion of dispersed particles relative to a transparent fluid under the influence of a spatially uniform electric field, a LCD (Liquid Crystal Display), an Organic EL (Electro-Luminescence), etc., so as to display an image and/or information represented by the data transferred from the supporting device 30 (otherwise, an image or information represented by the data processed in the data processing section 29), etc., thereon.

The operating section 25 is constituted by buttons, switches, a pressure sensitive touch panel in which transparent electrodes are arranged in a lattice pattern, etc., which are mounted on the display section 23. The pressure sensitive touch panel detects X and Y coordinate values at the pressed point selectively depressed by a finger, a touch pen, etc., as voltage values, so as to output the detected positional signals to the CPU 21 as the operational signals.

The communicating section 26 serves as an interface for coupling the information viewing apparatus 20 to the supporting device 30, and establishes the communication with the supporting device 30 by employing a wired communication, a wireless communication, an infrared communication, a Bluetooth (Registered Trade Mark) communication, etc.

The battery 27 can be recharged by electric power supplied from an information-viewing apparatus charging section 34, so as to supply electric power to each of the sections provided in the information viewing apparatus 20.

The mount detecting section 28 detects a status of inserting or removing the information viewing apparatus 20 into/from the supporting device 30. The scope of the detecting method applicable in the present invention is not specifically limited. For instance, it is possible to detect the mounting status by determining whether or not the battery 27 is coupled to the information-viewing apparatus charging section 34 of the supporting device 30, or it is also possible to detect the mounting status by determining whether or not an electrode attached to the information viewing apparatus 20 is electrically coupled to another electrode attached to the supporting device 30, or an electric contact point, which is turned ON or OFF by applying or removing the self weight of the information viewing apparatus 20, is disposed at the bottom section of the information viewing apparatus 20, so as to make it possible to detect the mounting status by determining whether the electric contact point is turned ON or OFF.

The data processing section 29 applies various kinds of conversion processing to the data acquired from the image forming apparatus 40 through the supporting device 30, as needed, so as to convert the acquired data to processed data suitable for the display purpose. For instance, in the case that the size of paper sheet, the resolution and the color mode, which are to be employed at the time when implementing the operation for writing onto the printing medium, do not coincide with those of the display section 23, the data processing section 29 applies a data size expansion/reduction processing, a high/low resolution conversion processing and a color/monochrome conversion processing to the acquired data, so as to make the size of paper sheet, the resolution and the color mode of the processed data coincide with those specified for the display section 23. Further, when the page allotment (integration) printing (for instance, 4in1 or 2in1 integration printing mode) and/or the duplex printing mode are/is employed for the purpose of saving the resources, since no problem would occur even if the images are displayed for every page on the information viewing apparatus 20, the acquired data is converted to processed data sets, each of which corresponds to each of the pages concerned. Still further, it is also applicable that the abovementioned data processing operations are implemented in any one of the image forming apparatus 40, the computer apparatus 50 and the supporting device 30. In this case, if the processed data is transferred, the data processing section 29 of the information viewing apparatus 20 can be omitted.

In this connection, although the display controller 24, the mount detecting section 28 and the data processing section 29 are configured as hardware in the exemplified configuration shown in FIG. 4, it is also applicable that those are configured as software programs to be executed by the controlling section (CPU 21).

### <Supporting Device>

The supporting device 30 is provided with a function for physically supporting the information viewing apparatus 20, another function for implementing the data communication with the information viewing apparatus 20 and the image forming apparatus 40, still another function for recharging the battery 27 provided in the information viewing apparatus 20, and is fixed onto the main frame of the image forming apparatus 40 or the attachment thereof (for instance, a paper sheet feeding section, a post processing section, etc.).

The supporting device 30 is structured in such a manner that the information viewing apparatus 20 can be inserted or removed into/from the supporting device 30. For instance, the supporting device 30, which is capable of supporting a single set of the information viewing apparatus 20, is formed by a frame member as shown in FIG. 2. The frame member has an opening section, which makes it possible for the user to view a part of or all of the display section 23 of the information viewing apparatus 20 from a direction straightly opposing to the display section 23 (direction orthogonal to the displaying surface of the display section 23) in such a state that the information viewing apparatus 20 is loaded onto the supporting device 30. However, the scope of the shape of the supporting device 30 is not limited to that indicated by the schematic diagram shown in FIG. 2. For instance, a structure for supporting only the lower section of the information viewing apparatus 20 is also applicable in the present invention, or a cubically structured body, having a slot into which the information viewing apparatus 20 can be detachably inserted, is also applicable in the present invention. Further, the shape of the opening section is changeable according to that of the display section 23 of the information viewing apparatus 20. Still further, a transparent protective member, such as a glass sheet, a plastic sheet, etc., may be fitted into the opening section so as to protect the surface of the display section 23 of the information viewing apparatus 20 from damage.

On the other hand, the supporting device 30, which is capable of supporting a plurality of the information viewing apparatuses 20, is formed as a cubically structured body provided with a plurality of slots, a depth of each of which is set at such a size that makes it possible for the user to view a part of or all of the display section 23 of the information viewing apparatus 20 from a direction straightly opposing to the display section 23 in such a state that the information viewing apparatus 20 is loaded onto the supporting device 30. However, the scope of the shape of the supporting device 30 is not limited to that indicated by the schematic diagram shown in FIG. 3. For instance, it is applicable that the supporting device 30 is structured as a duplicated frame structure by combining a plurality of frame members, each of which is similar to that shown in FIG. 2, or it is also applicable that the supporting device 30 is so structured that a plurality of information viewing apparatuses 20 can be supported in either stepwise or inclined postures. Further, although the shapes of the information viewing apparatuses 20, shown in FIG. 3, are the same as each other, it is also applicable that shapes of the information viewing apparatuses 20 concerned are different from each other, and it is also applicable that the shape of each of the slots is independently changeable, so as to make it possible to support the information viewing apparatuses 20, the outer shapes of which are different form each other.

Further, as shown in FIG. 5, the supporting device 30 is provided with a CPU (Central Processing Unit) 31, a storage device 32, an information viewing apparatus communicating section 33, the information viewing apparatus charging section 34, an information viewing apparatus detecting section 35, a visible display area setting section 36, an image forming apparatus communicating section 37, an electric power source 38, etc.

The CPU 31 executes various kinds of programs read from the storage device 32 so as to control the operations to be conducted in the various kinds of sections. The storage device 32 is constituted by a ROM (Read Only Memory) and a RAM (Random Access Memory), so as to store the various kinds of programs to be executed by the CPU 31, setting information for controlling the operations to be conducted by the supporting device 30, various kinds of data representing images to be displayed on the information viewing apparatus 20, therein. Further, the CPU 31 and the storage device 32 constitute a controlling section.

The information viewing apparatus communicating section 33 serves as an interface for coupling a single set of information viewing apparatus 20 or a plurality of the information viewing apparatuses 20 to the supporting device 30, and establishes the communication with each of the information viewing apparatuses 20 by employing a wired communication, a wireless communication, an infrared communication, a Bluetooth (Registered Trade Mark) communication, etc.

The information viewing apparatus charging section 34 supply electric power, generated by the electric power source 38, to the battery 27 of each of the information viewing apparatuses 20 concerned, so as to recharge the battery 27.

The information viewing apparatus detecting section 35 detects a loading status of the information viewing apparatus 20. In addition, when a plurality of information viewing apparatuses 20 is loaded onto the supporting device 30, the information viewing apparatus detecting section 35 specifies one of the information viewing apparatuses 20, which is viewable from the direction straightly opposed to the user, (for instance, the information viewing apparatus 20 loaded at the foremost position) or another one of the information viewing apparatuses 20, which is correlated with the user who currently view the data to be transferred. The scope of the method for detecting the loading status or the loaded position of the information viewing apparatus 20, which is applicable in the present invention, is not specifically limited. For instance, it is possible to detect the loading status or the loaded position by determining whether or not the battery 27 of the information viewing apparatus 20 is coupled to the information-viewing apparatus charging section 34, or it is also possible to detect the loading status or the loaded position by determining whether or not an electrode attached to the information viewing apparatus 20 is electrically coupled to another electrode attached to each of the slots of the supporting device 30, or an electric contact point, which is turned ON or OFF by applying or removing the self weight of the information viewing apparatus 20, is disposed at the bottom section of each of the slots of the supporting device 30, so as to make it possible to detect the loading status or the loaded position by determining whether the electric contact point is turned ON or OFF.

Based on the structures of the supporting device 30 and the information viewing apparatus 20, the visible display area setting section 36 establishes a visible display area within the display section 23 of the information viewing apparatus 20, which is to be exposed from the supporting device 30. For instance, with respect to the structure shown in FIG. 2, the visible display area setting section 36 establishes an area that is not shaded by the frame member of the supporting device 30 as the visible display area, while, with respect to the structure shown in FIG. 3, the visible display area setting section 36 establishes an area that is not covered by the slot section of the supporting device 30 as the visible display area. Further, when a plurality of information viewing apparatuses 20 is supported in a stepwise manner, as shown in FIG. 10b, the visible display area setting section 36 establishes an area that is not shaded by another information viewing apparatus located in front of an information viewing apparatus concerned as the visible display area.

The image forming apparatus communicating section 37 serves as an interface for coupling the supporting device 30 to the image forming apparatus 40, and establishes the communication with the image forming apparatus 40 by employing a wired communication, a wireless communication, an infrared communication, a Bluetooth (Registered Trade Mark) communication, etc.

The electric power source 38 supplies electric power to various kinds of sections included in the supporting device 30, so as to activate them.

In this connection, although the information viewing apparatus detecting section 35 and the visible display area setting section 36 are configured as hardware in the configuration shown in FIG. 5, it is also applicable that these are configured as software programs to be executed by the controlling section (CPU 31).

### <Image Forming Apparatus>

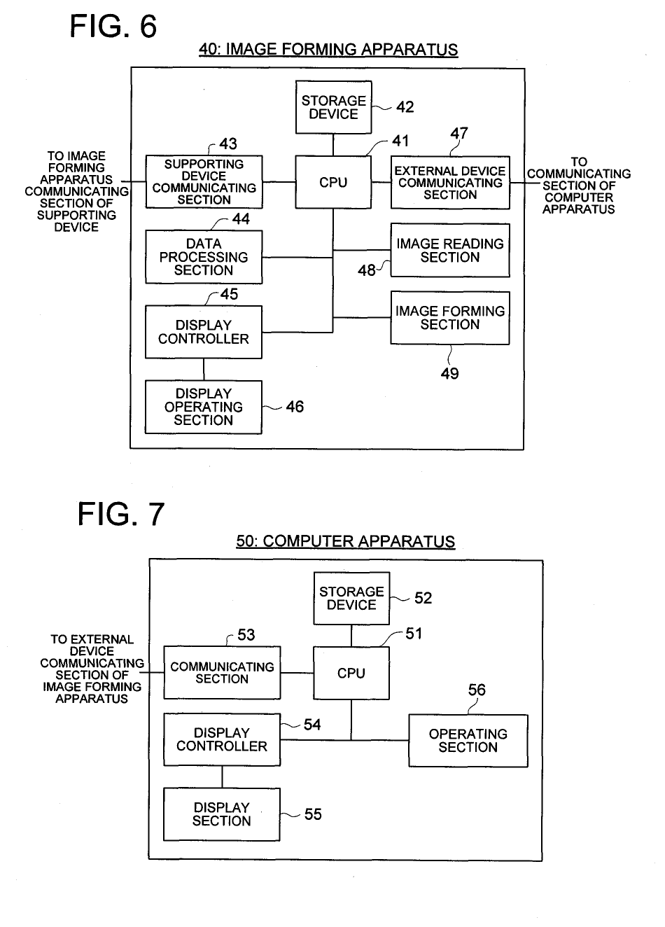

As shown in FIG. 6, the image forming apparatus 40 is provided with a CPU (Central Processing Unit) 41, a storage device 42, a supporting device communicating section 43, a data processing section 44, a display controller 45, a display operating section 46, an external device communicating section 47, an image reading section 48, an image forming section 49, etc.

The CPU 41 executes various kinds of programs read from the storage device 42 so as to control the operations to be conducted in the various kinds of sections. The storage device 42 is constituted by a ROM (Read Only Memory), a RAM (Random Access Memory), etc., so as to store the various kinds of programs to be executed by the CPU 41, setting information for controlling the operations to be conducted by the image forming apparatus 40, identification information for identifying the user, a list to be referred at the time when determining whether or not an operation for changing a writing medium should be implemented (writing medium change determination list, detailed later), etc., therein. Further, the CPU 41 and the storage device 42 constitute a controlling section.

The controlling section abovementioned monitors the current status of the image forming apparatus 40 so as to detect an abnormal trouble of the image forming apparatus 40, such as a jamming of paper sheet, a running out of paper sheet, a running out of toner ink, etc. Further, the controlling section also monitors the processing status of the job received from the computer apparatus 50 so as to determine whether or not the job waiting status occurs. Still further, the controlling section periodically implements a calibration processing for maintaining the print quality. Yet further, the controlling section communicates with either the supporting device 30 or the information viewing apparatus 20 loaded onto the supporting device 30 so as to monitor the usage status of the information viewing apparatus 20 (such as an currently available storage capacity of the information viewing apparatus 20, information in regard to the correlating relationships between the concerned users and plural sets of information viewing apparatuses 20 currently loaded onto the information viewing apparatus 20, etc.). Then, the controlling section make it possible to establish whether or not the operation for changing the data writing medium should be implemented, from a medium change setting screen turned from a jam occurrence notification screen, detailed later, and in case that one of abnormal troubles, such as a jamming of paper sheet, a running out of paper sheet, a running out of toner ink, a job waiting standby state, a calibration waiting standby state, etc., has occurred, when the operation for writing the data (image) onto the printing medium is instructed, the controlling section changes the data writing destination from the printing medium to the information viewing apparatus 20 according to the setting information. On the contrary, when the operation for writing the data (image) into the information viewing apparatus 20 is instructed, in case that it is impossible to communicate with the information viewing apparatus 20 loaded onto the supporting device 30, in case that no available storing capacity remains or in case that the information viewing apparatus 20 concerned is currently correlated with the other user, the controlling section changes the data writing destination from the information viewing apparatus 20 to the printing medium, according to the setting information.

The supporting device communicating section 43 serves as an interface for coupling the image forming apparatus 40 to the supporting device 30, and establishes the communication with the supporting device 30 by employing a wired communication, a wireless communication, an infrared communication, a Bluetooth (Registered Trade Mark) communication, etc.

The data processing section 44 parses the job received from the computer apparatus 50 so as to extract the setting information, such as an output condition, etc., therefrom, and rasterizes each of print data sets corresponding to each of the page images included in the job, so as to create bitmap data serving as a printable data format, and further, applies various kinds of image processing, such as a color conversion processing, a density adjustment processing, etc., to the bitmap data above-created. Further, the data processing section 44 conducts the processing operation for converting the data, received from computer apparatus 50, to such data that is suitable for displaying an image onto the information viewing apparatus 20, as needed. For instance, in the case that the size of paper sheet, the resolution and the color mode, which are to be employed at the time when implementing the operation for writing onto the printing medium, do not coincide with those of the display section 23 of the information viewing apparatus 20, the data processing section 44 applies a data size expansion/reduction processing, a high/low resolution conversion processing and a color/monochrome conversion processing to the data received from the computer apparatus 50, so as to make the size of paper sheet, the resolution and the color mode of the processed data coincide with those specified for the display section 23 of the information viewing apparatus 20. Further, when the page allotment (integration) printing (for instance, 4in1 or 2in1 integration printing mode) and/or the duplex printing mode are/is employed, since no problem would occur even if the images are displayed for every page on the information viewing apparatus 20, the received data is converted to processed data sets, each of which corresponds to each of the pages concerned.

The display operating section 46 includes the pressure sensitive touch panel, which is constituted by the transparent electrodes arranged in a lattice pattern so as to cover a displaying screen of a display device, such as a LCD (Liquid Crystal Display), an Organic EL (Electro-Luminescence), etc. Based on the instruction signals issued by the display controller 45, the display operating section 46 displays the jam occurrence notification screen, the medium change setting screen, etc., and the pressure sensitive touch panel detects X and Y coordinate values at the pressed point selectively depressed by a finger, a touch pen, etc., as voltage values, so as to output the detected positional signals to the CPU 41 as the operational signals.

The external device communicating section 47 serves as an interface for coupling the image forming apparatus 40 to the computer apparatus 50, and is constituted by a NIC (Network Interface Card), a modem, etc., so as to establish the communication with the computer apparatus 50 by employing a wired communication method, a wireless communication method, etc.

The image reading section 48 optically reads an image residing on a document paper sheet placed on the document placing plate, and is constituted by a light source that emits a light beam to be scanned onto the document paper sheet, a CCD (Charge Coupled Device) image sensor that converts the light reflected from the document paper sheet to electric signals, an analogue to digital converter that converts the electric signals to digital image data, etc.

The image forming section 49 is constituted by various kinds of functional constituents being necessary for implementing the image forming operation, which employs an image forming process, such as the electro-photographic process, the electrostatic recording process or the like, namely, the various kinds of functional constituents include a charging device, a photoreceptor drum, an exposing device, a transferring roller, a transferring belt, a fixing device, etc. Concretely speaking, the exposing device irradiates the light beam, intensity of which is modulated on the basis of the bitmap data representing the image to be printed, onto the photoreceptor drum uniformly charged by the charging device, so as to form an electrostatic latent image thereon. Successively, the developing device develops the electrostatic latent image by making toner adhere onto the circumferential surface of the photoreceptor drum, so as to form a visible toner image thereon. Still successively, the toner image formed on the photoreceptor drum is transferred onto the transferring belt under the transferring action of a primary transferring roller, and then, further transferred onto the printing medium from the transferring belt under the transferring action of a secondary transferring roller. Finally, the toner image transferred onto the printing medium is fixed thereon by the fixing device.

In this connection, although the data processing section 44 shown in FIG. 6 is configured as hardware, it is also applicable that the data processing section 44 is configured as software programs to be executed by the controlling section (CPU 31). Further, it is applicable that the image forming apparatus 40 is provided with at least the supporting device 30, the function for communicating with the computer apparatus 50, and a space into which the supporting device 30 is installable. Accordingly, the image reading section 48, etc. are omittable, and the image forming apparatus 40 may include a post processing section and/or a facsimile communicating section.

### <Computer Apparatus>

As shown in FIG. 7, the computer apparatus 50 is provided with a CPU (Central Processing Unit) 51, a storage device 52, a communicating section 53, a display controller 54, a display section 55, a operating section 56, etc.

The CPU 51 executes various kinds of programs read from the storage device 52, so as to control the operations to be conducted in the various kinds of sections. The storage device 52 is constituted by a ROM (Read Only Memory), a RAM (Random Access Memory), etc., so as to store the various kinds of programs to be executed by the CPU 51, setting information for controlling the operations to be conducted in the computer apparatus 50, therein. Further, the CPU 51 and the storage device 52 constitute a controlling section that also serves as a printer driver for creating data written in the Page Description Language, such as the PS (Post Script), the PCL (Printer Control Language), etc., PDF (Portable Document Format) data, etc., and for transmitting the print job to the image forming apparatus 40.

The abovementioned printer driver is so constituted that it is possible to establish whether or not the operation for changing the medium onto which data is to be written should be implemented, from the screen for establishing the output condition of the data concerned (print property screen, detailed later), and writes the abovementioned output condition and the medium change setting into the header of the print job concerned, etc. Further, it is also possible to apply various kinds of conversion processing to the data to be transmitted, so as to convert the concerned data to processed data suitable for the displaying operation in the information viewing apparatus 20. For instance, in the case that the size of paper sheet, the resolution and the color mode, which are to be employed at the time when implementing the operation for writing onto the printing medium, do not coincide with those of the display section 23 of information viewing apparatus 20, the printer driver applies a data size expansion/reduction processing, a high/low resolution conversion processing and a color/monochrome conversion processing to the acquired data, so as to make the size of paper sheet, the resolution and the color mode of the processed data coincide with those specified for the display section 23. Further, when the page allotment (integration) printing (for instance, 4in1 or 2in1 integration printing mode) and/or the duplex printing mode are/is employed, since no problem would occur even if the images are displayed for every page on the information viewing apparatus 20, the concerned data is converted to processed data sets, each of which corresponds to each of the pages concerned. Then, after implementing the data processing operation abovementioned, the printer driver transmits both the data for the image forming apparatus 40 and the other data for the information viewing apparatus 20 to the image forming apparatus 40.

The communicating section 53 serves as an interface for coupling the computer apparatus 50 to the image forming apparatus 40, and is constituted by a NIC (Network Interface Card), a modem, etc., so as to establish the communication with the image forming apparatus 40 by employing a wired communication, a wireless communication, etc.

The display section 55 is constituted by a LCD (Liquid Crystal Display) device, an Organic EL (Electric Luminescence) device, etc., so as to display an application screen for creating data to be viewed, a print property screen for establishing output conditions, etc., thereon, according to the instructions issued by the display controller 54.

The operating section 56 is constituted by a keyboard, a mouse, etc., so as to make it possible to conduct various kinds of inputting operations, such as a data creating operation, an output condition establishing operation, etc.

In this connection, the system, indicated by the schematic diagrams shown in FIG. 1 through FIG. 7, is merely one of examples of the information viewing system 10 embodied in the present invention. Any kind of information viewing system may be applicable in the present invention, as far as the system is so constituted that it is possible to select whether the data to be viewed is written into the printing medium or the information viewing apparatus 20 (displayable medium). For instance, when the data read by the image reading section 48 of the image forming apparatus 40 is outputted, it is possible to omit the computer apparatus 50.

Next, the operations to be conducted by the information viewing system 10 configured as abovementioned will be detailed in the following.

Initially, referring to the flowchart shown in FIG. 8, the operations to be conducted in such a case that the writing medium change operation is always implemented, will be detailed in the following.

When the user operates the operating section 56 of the computer apparatus 50 so as to select specific data based on which the user wishes to implement a writing operation (Step S101), the controlling section (printer driver) of the computer apparatus 50 makes the display section 55 display the output condition setting screen. Successively, when the user operates the operating section 56 so as to establish the writing destination medium (either the printing medium or the information viewing apparatus 20) (Step S102), and to establish various kinds of parameters in regard to the color mode, the paper sheet feeding tray, the image size enlargement/reduction, the single-side/duplex printing, etc., (Step S103), the printer driver creates a job of the Page Description Language, and issues a writing request to the image forming apparatus 40 (Step S104).

Receiving the job sent from the computer apparatus 50, the controlling section of the image forming apparatus 40 determines whether the instruction, included in the job concerned, indicates that the writing operation should be implemented for the printing medium or the information viewing apparatus 20 (in other words, whether the writing destination medium is the printing medium or the information viewing apparatus 20) (Step S105). When determining that the writing destination medium is the printing medium (Step S105; Yes), the controlling section refers to a writing medium change determining list, so as to further determine whether or not it is possible to instantaneously conduct the operation for writing an image represented by the data concerned (hereinafter, referred to as the data writing operation, for simplicity) onto the printing medium (Step S106). When determining that it is possible to instantaneously conduct the data writing operation onto the printing medium (Step S106; Yes), the controlling section implements the data writing operation onto the printing medium (Step S108), while when determining that it is impossible (Step S106; No), the controlling section changes the writing destination medium from the printing medium to the information viewing apparatus 20 and implements the data writing operation onto the information viewing apparatus 20 (Step S107).

FIG. 13 shows a schematic diagram indicating an example of the writing medium change determining list, in which writable media to be employed in various kinds of statuses of the image forming apparatus 40 are indicated. For instance, during the operation for printing images onto the printing media, sometimes, an image adjustment processing is applied to the image data representing the images concerned, so as to prevent a color appearance of the reproduced images from changing due to changes of the environmental situations and/or a durability of the unit concerned. Once the image adjustment processing is applied, the data writing operation onto the printing media is disabled until the image adjustment processing is completed. However, since the data writing operation onto the information viewing apparatus 20 is still enabled, the writing destination medium is changed from the printing media to the information viewing apparatus 20. Further, just after the image forming apparatus 40 has been recovered from a sleeping status, which is implemented for the purpose of suppressing the electric power consumption of the image forming apparatus 40, or when any one of troubles, such as an empty of paper sheets, a paper sheet jamming, a malfunction of motor mechanism, etc., or when the durable life of the concerned unit has elapsed, or the like, since the data writing operation onto the printing media is also disabled, the writing destination medium is changed from the printing media to the information viewing apparatus 20 as well.

In this connection, when the writing destination medium is changed to the information viewing apparatus 20, it is applicable that the data processing section 29 of the information viewing apparatus 20 converts the data, representing the images to be written on the printing media, to a kind of converted data being suitable for the information viewing apparatus 20.

Concretely speaking, when a plurality of information viewing apparatuses 20 is loaded onto the supporting device 30 as shown in FIG. 10a, the current settings of the printing medium are automatically changed to revised settings at the time when the writing destination medium is changed from the printing medium to the information viewing apparatus 20. For instance, in the case that the sizes of the printing medium and the information viewing apparatus 20 are A3 size and A4 size, respectively, the current setting of A3 size is automatically converted to A4 size, so as to conduct the data writing operation onto the information viewing apparatus 20 with the reduced image size. Further, when the plurality of information viewing apparatuses 20 is loaded onto the supporting device 30, and plural jobs, which are respectively correlated to plural users being different from each other, are received, it is also possible to conduct the data writing operation by sorting the plural jobs into the plural users concerned.

Further, according to the configuration shown in FIG. 10b, it is possible to load a plurality of information viewing apparatuses 20 having specifications being different from each other, such as specifications for a monochrome image displaying use or specifications for a color image displaying use. In this configuration, when the writing destination medium is changed to information viewing apparatus 20, it is possible to select a specific one of the information viewing apparatuses 20, parameters of which, such as a color/monochrome image forming mode, an image size, etc., coincides with those established in the job concerned, so as to conduct the data writing operation onto the above-selected specific one of the information viewing apparatuses 20. As a result, it becomes possible to conduct the data writing operation onto the information viewing apparatus 20 in such a state that is similar to that onto the printing medium.

Returning to the flowchart shown in FIG. 8, when determining that the writing destination medium is the information viewing apparatus 20 (Step S105; No), the controlling section refers to the writing medium change determining list, so as to further determine whether or not it is possible to instantaneously conduct the data writing operation onto the information viewing apparatus 20 (Step S109). When determining that it is possible to instantaneously conduct the data writing operation onto the information viewing apparatus 20 (Step S109; Yes), the controlling section converts the data to the converted data being suitable for the information viewing apparatus 20 as needed, and then, implements the data writing operation onto the information viewing apparatus 20 (Step S111). On the other hand, when determining that it is impossible (Step S109; No), the controlling section changes the writing destination medium from the information viewing apparatus 20 to the printing medium so as to implement the data writing operation onto the printing medium (Step S110).

Referring to the writing medium change determining list shown in FIG. 13, the medium change operation will be detailed in the following. In case of occurrence of an empty status of information viewing apparatus 20 (such as out of storage capacity or correlated to the other user) or a trouble in the communication system for communicating with the supporting device 30, the data writing operation onto the information viewing apparatus 20 becomes impossible. However, since the data writing operation onto the printing medium is still possible, the writing destination medium is changed from the information viewing apparatus 20 to the printing medium.

As abovementioned, by automatically changing the writing destination medium according to the list created in advance, it becomes possible to prevent the user from waiting the commencement of the output operation, resulting in drastic improvement of the user's usability.

Next, referring to the flowchart shown in FIG. 9, the processes for implementing the writing medium change operation, which are to be conducted according to the user's established determination of change or not, will be detailed in the following.

As well as the aforementioned, when the user operates the operating section 56 of the computer apparatus 50 so as to select specific data based on which the user wishes to implement a writing operation (Step S201), the controlling section (printer driver) of the computer apparatus 50 makes the display section 55 display the output condition setting screen. Successively, when the user operates the operating section 56 so as to establish the writing destination medium (either the printing medium or the information viewing apparatus 20) (Step S202).

In this connection, various kinds of data that represent various kinds of documents, such as information materials to be viewed at the individual user's desk, information materials to be used in a meeting of a small number of persons, information materials to be distributed among participants of a conference, etc., would be employed as the data representing the images and/or documents to be written onto the printing medium or the information viewing apparatus 20 by the user. Further, according to a phase for using the data, the user would designate either the printing medium or the information viewing apparatus as the writing destination medium, or sometimes, any one of the printing medium and the information viewing apparatus is acceptable for the user as the writing destination medium, as far as the image or the document can be written therein. In the latter case, there will arise no problem even if the writing medium change operation is automatically implemented according to the flowchart shown in FIG. 8. However, in the former case, if the writing medium change operation were automatically implemented, there would possibly occur such a case that the result of the writing medium change operation does not coincide with the user's demand. For instance, when a number of information viewing apparatuses 20 is smaller than that of participants in the conference, if the writing destination medium were changed from the printing medium to the information viewing apparatus 20, all of the participants in the conference cannot necessary view the information materials concerned.

To overcome the abovementioned drawback, the controlling section (printer driver) makes the display section 55 display a print property screen 60, as indicated by the schematic diagrams shown in FIG. 11a and FIG. 11b, so as to make it possible to determine whether the implementation of the writing medium change operation should be enabled or disabled, when the user establishes the various kinds of parameters, such as the color mode, the size, etc. Concretely speaking, FIG. 11a shows a schematic diagram indicating a conventional print property screen, while FIG. 11b shows another schematic diagram indicating a novel print property screen embodied in the present invention. As shown in FIG. 11b, according to the novel print property screen, a tub for change mode and buttons for respectively enabling and disabling the implementation of the writing medium change operation are newly added to the conventional print property screen shown in FIG. 11a, so as to make it possible to select whether the implementation of the writing medium change operation should be enabled or disabled.

Returning to the flowchart shown in FIG. 9, the user operates the operating section 56 so as to establish any one of enabling and disabling the implementation of the writing medium change operation (Step S203), and to establish various kinds of parameters in regard to the color mode, the paper sheet feeding tray, the image size enlargement/reduction, the single-side/duplex printing, etc., (Step S204), the printer driver creates a job of the Page Description Language, and issues a writing request to the image forming apparatus 40 (Step S205).

Receiving the job sent from the computer apparatus 50, the controlling section of the image forming apparatus 40 determines whether the instruction, included in the job concerned, indicates that the writing operation should be implemented for the printing medium or the information viewing apparatus 20 (Step S206). When determining that the writing destination medium is the printing medium (Step S206; Yes), the controlling section refers to the writing medium change determining list shown in FIG. 13, so as to further determine whether or not it is possible to instantaneously conduct the data writing operation onto the printing medium (Step S207). When determining that it is possible to instantaneously conduct the data writing operation onto the printing medium (Step S207; Yes), the controlling section implements the data writing operation onto the printing medium (Step S211).

On the other hand, when determining that it is impossible to instantaneously conduct the data writing operation onto the printing medium (Step S207; No), the controlling section determines whether or not the operation for changing the writing destination medium from the printing medium to the information viewing apparatus 20 should be implemented (namely, determining whether or not the implementation of the writing medium change operation is established as enabled from the print property screen 60) (Step S208). When implementing the writing medium change operation and the data writing operation, (Step S208; Yes), the controlling section converts the data to the converted data being suitable for the information viewing apparatus 20 as needed, and then, implements the data writing operation onto the information viewing apparatus 20 (Step S209). On the other hand, when not implementing the writing medium change operation and the data writing operation (Step S208; No), the controlling section suspends the job for implementing the data writing operation onto the printing medium concerned (Step S210).

Further, when determining that the writing destination medium is the information viewing apparatus 20 (Step S206; No), the controlling section refers to the writing medium change determining list, so as to further determine whether or not it is possible to instantaneously conduct the data writing operation onto the information viewing apparatus 20 (Step S212). When determining that it is possible to instantaneously conduct the data writing operation onto the information viewing apparatus 20 (Step 5212; Yes), the controlling section converts the data to the converted data being suitable for the information viewing apparatus 20 as needed, and then, implements the data writing operation onto the information viewing apparatus 20 (Step S216). On the other hand, when determining that it is impossible to instantaneously conduct the data writing operation onto the information viewing apparatus 20 (Step S212; No), the controlling section determines whether or not the operation for changing the writing destination medium from the information viewing apparatus 20 to the printing medium should be implemented (namely, determining whether or not the implementation of the writing medium change operation is established as enabled from the print property screen 60) (Step S213). When implementing the writing medium change operation and the data writing operation (Step S213; Yes), the controlling section implements the data writing operation onto the printing medium (Step S214). On the other hand, when not implementing the writing medium change operation and the data writing operation (Step S213; No), the controlling section suspends the job for implementing the data writing operation onto the information viewing apparatus concerned (Step S215).

As abovementioned, according to the present embodiment, when issuing a request for data writing operation, the computer apparatus 50 requests the user to determine whether or not the writing medium change operation should be implemented, so as to add the result established by the user to the job concerned. Successively, the image forming apparatus 40 implements the writing medium change operation based on the result above-established by the user. Therefore, it becomes possible for the user to prevent such an inconvenience that the images of the concerned job are outputted from the media being unintended by the user.

In this connection, although, according to the flowchart shown in FIG. 9, either enabling or disabling the writing medium change operation is established at the computer apparatus 50, it is also applicable that the system is so constituted that either enabling or disabling the writing medium change operation is established at the image forming apparatus 40, instead of or in addition to the establishment made in the computer apparatus 50.

For instance, it is applicable that a screen for establishing whether the writing medium change operation is enabled or disabled, is displayed on the display operating section 46 of the image forming apparatus 40, so that the user can input the desired establishment therefrom. Further, in case that a certain problem, such as a jamming of paper sheet, a running out of paper sheet, a running out of toner ink, a job waiting standby state, a calibration waiting standby state, a communicating malfunction between the supporting device 30 and the information viewing apparatus 20, a shortage of the storage capacity of the information viewing apparatus 20, an absence of information viewing apparatus 20 being currently allot-able, etc., has occurred, the image forming apparatus 40 displays a notification screen 61, as shown in FIG. 12a, so as to notify the user of the occurrence of the problem. Accordingly, it is also applicable that the system is so constituted that the notification screen 61 is shifted to a medium change setting screen 62, shown in FIG. 12b, when the user selects a job currently in mid-course of printing or in a print waiting status from the notification screen 61, so that, when the user clicks the button of “Yes” disposed, in the medium change setting screen 62, the data writing operation onto the information viewing apparatus 20 is implemented.

As mentioned in the above, by making it possible for the user to determine at the image forming apparatus 40 whether the writing medium change operation is enabled or disabled, it becomes possible for the user to determine whether or not the writing medium change operation should be implemented, corresponding to the problem currently occurring. For instance, in case of occurrence of a speedily restorable problem, such as the jamming of paper sheet, the running out of paper sheet or the like, it is possible to resume the data writing operation onto the printing media by removing the jammed paper sheet, or by replenishing the paper-sheet feeding tray with paper sheets. On the other hand, in case of occurrence of a time consuming problem, such as the running out of toner ink, the job waiting standby state, the calibration waiting standby state or the like, it is possible to speedily output the images represented by the concerned data onto the information viewing apparatus 20, by changing the writing destination medium from the printing medium to the information viewing apparatus 20.

Incidentally, the scope of the present invention is not limited to the embodiments described in the foregoing. Modifications and additions made by a skilled person without departing from the spirit and scope of the invention shall be included in the scope of the present invention. For instance, although the system, described in the foregoing as the embodiment of the present invention, is so constituted that the user selects any one of the data writing operation onto the printing medium and the other data writing operation onto the information viewing apparatus 20, which are to be conducted by the image forming apparatus 40, it is also applicable that the system is so constituted that the user can select any one of various kinds of data writing operations onto different kinds of media.

The present invention is available for a system that includes an information viewing apparatuses, such as an electronic paper sheet or the like, and an image forming apparatus.

According to any one of the information viewing system, the image forming apparatus and the information viewing apparatus, embodied in the present invention, it becomes possible to speedily output an image represented by data even when an operation for outputting the image represented by the data onto a predetermined medium is disabled.

This is because, in the image forming apparatus, to which a supporting device that is configured to detachably support at least a single set of an information viewing apparatus is coupled, in case that the data writing operation, defined as the operation for writing the image represented by the data, onto the printing medium becomes impossible at the time of commencing the data writing operation or in mid-course of implementing the data writing operation onto the printing medium, while the data writing operation onto the information viewing apparatus is enabled, the controlling section changes the writing destination medium from the printing medium to the information viewing apparatus, in order to continuously implement the data writing operation onto the information viewing apparatus instead of the printing medium.

Further, in case that the data writing operation onto the information viewing apparatus becomes impossible at the time of commencing the data writing operation or in mid-course of implementing the data writing operation onto the information viewing apparatus, while the data writing operation onto the printing medium is enabled, the controlling section changes the writing destination medium from the information viewing apparatus to the printing medium, in order to continuously implement the data writing operation onto printing medium instead of the information viewing apparatus.

While the preferred embodiments of the present invention have been described using specific term, such description is for illustrative purpose only, and it is to be understood that changes and variations may be made without departing from the spirit and scope of the appended claims.

What is claimed is:

1. An information viewing system, comprising:
at least a single set of an information viewing apparatus provided with a display section;
a supporting device that is configured to detachably support the information viewing apparatus;
an image forming apparatus onto which the supporting device is mountable; and
a computer apparatus that instructs the image forming apparatus to output an image represented by data;
wherein the information viewing apparatus, the supporting device, the image forming apparatus and the computer apparatus are communicatively coupled to each other, so as to make it possible to select any one of a printing medium accommodated in the image forming apparatus and the information viewing apparatus mounted on the supporting device as a writing destination medium, when the image represented by the data is to be outputted onto the writing destination medium; and
wherein, in case that a data writing operation, defined as an operation for writing the image represented by the data, onto the printing medium becomes impossible at a time of commencing the data writing operation or in mid-course of implementing the data writing operation onto the printing medium, while the data writing operation onto the information viewing apparatus is enabled, the image forming apparatus changes the writing destination medium from the printing medium to the information viewing apparatus, in order to implement the data writing operation onto the information viewing apparatus instead of the printing medium; and
wherein, in case that the data writing operation onto the information viewing apparatus becomes impossible at a time of commencing the data writing operation or in mid-course of implementing the data writing operation onto the information viewing apparatus, while the data writing operation onto the printing medium is enabled, the image forming apparatus changes the writing destination medium from the information viewing apparatus to the printing medium, in order to implement the data writing operation onto printing medium instead of the information viewing apparatus.

2. The information viewing system of claim 1,
wherein, when changing the writing destination medium, the image forming apparatus also changes output conditions of the data, corresponding to the writing destination medium to be changed.

3. The information viewing system of claim 1,
wherein, when changing the writing destination medium from the printing medium to one of plural information viewing apparatuses currently supported by the supporting device, the image forming apparatus selects such an information viewing apparatus that is in conformity with output conditions of the data from the plural information viewing apparatuses as the information viewing apparatus.

4. The information viewing system of claim 2,
wherein the output conditions include at least any one of an output image size, a resolution, a color/monochrome printing mode, a page allotment and a single-side/duplex printing mode.

5. The information viewing system of claim 1,
wherein, when receiving plural data sets, which are respectively related to plural users being different from each other, and when changing the writing destination medium from the printing medium to the information viewing apparatus, the image forming apparatus discretely writes each of the plural data sets onto corresponding one of information viewing apparatuses, which are respectively allotted to the plural users.

6. The information viewing system of claim 1,
wherein, when instructing the data writing operation, the computer apparatus is capable of determining whether an operation for changing the writing destination medium is enabled or disabled; and
wherein the image forming apparatus implements the operation for changing the writing destination medium, when the computer apparatus has determined that the operation for changing the writing destination medium should be enabled.

7. The information viewing system of claim 1,
wherein, before receiving the data or when the data writing operation onto a predetermined medium becomes impossible, the image forming apparatus is capable of determining whether an operation for changing the writing destination medium is enabled or disabled; and
wherein the image forming apparatus implements the operation for changing the writing destination medium, when the image forming apparatus has determined that the operation for changing the writing destination medium should be enabled.

8. An image forming apparatus onto which a supporting device that is configured to detachably support at least a single set of an information viewing apparatus, provided with a display section, is mountable, the image forming apparatus comprising:
a data processing section to output data representing an image to be printed or displayed onto a writing destination medium; and
a controlling section to select any one of a printing medium and the information viewing apparatus as the writing destination medium, when the image represented by the data is to be outputted onto the writing destination medium;
wherein, in case that a data writing operation, defined as an operation for writing the image represented by the data, onto the printing medium becomes impossible at a time of commencing the data writing operation or in mid-course of implementing the data writing operation onto the printing medium, while the data writing operation onto the information viewing apparatus is enabled, the controlling section changes the writing destination medium from the printing medium to the information viewing apparatus, in order to implement the data writing operation onto the information viewing apparatus instead of the printing medium; and
wherein, in case that the data writing operation onto the information viewing apparatus becomes impossible at a time of commencing the data writing operation or in mid-course of implementing the data writing operation onto the information viewing apparatus, while the data writing operation onto the printing medium is enabled, the controlling section changes the writing destination medium from the information viewing apparatus to the printing medium, in order to implement the data writing operation onto printing medium instead of the information viewing apparatus.

9. The image forming apparatus of claim 8,
wherein, when changing the writing destination medium, the controlling section also changes output conditions of the data, corresponding to the writing destination medium to be changed.

10. The image forming apparatus of claim 8,
wherein, when changing the writing destination medium from the printing medium to one of plural information viewing apparatuses currently supported by the supporting device, the controlling section selects such an information viewing apparatus that is in conformity with output conditions of the data from the plural information viewing apparatuses as the information viewing apparatus.

11. The image forming apparatus of claim 9,
wherein the output conditions include at least any one of an output image size, a resolution, a color/monochrome printing mode, a page allotment and a single-side/duplex printing mode.

12. The image forming apparatus of claim 8,
wherein, when receiving plural data sets, which are respectively related to plural users being different from each other, and when changing the writing destination medium from the printing medium to the information viewing apparatus, the controlling section discretely writes each of the plural data sets onto corresponding one of information viewing apparatuses, which are respectively allotted to the plural users.

13. The image forming apparatus of claim 8,
wherein, before receiving the data or when the data writing operation onto a predetermined medium becomes impossible, the controlling section is capable of determining whether an operation for changing the writing destination medium is enabled or disabled; and
wherein the controlling section implements the operation for changing the writing destination medium, when the controlling section has determined that the operation for changing the writing destination medium should be enabled.

14. An information viewing apparatus, which is supported by a supporting device that is configured to detachably support the information viewing apparatus and that is mounted onto an image forming apparatus, the information viewing apparatus comprising:
a display section to display an image thereon; and
a data processing section that is configured to change output conditions of data representing the image, corresponding to the information viewing apparatus, so as to display the image represented by the data onto the display section, when the image forming apparatus changes a writing destination medium, onto which a data writing operation, defined as an operation for writing the image represented by the data, is to be implemented, to the information viewing apparatus concerned.

15. The information viewing apparatus of claim 14,
wherein the output conditions include at least any one of an output image size, a resolution, a color/monochrome printing mode, a page allotment and a single-side/duplex printing mode.
